(19) United States
(12) Patent Application Publication
(10) Pub. No.: US 2010/0311007 A1
(43) Pub. Date: Dec. 9, 2010

(54) Gingival massaging device

(76) Inventor: Avraham Eliyahov, Tel Aviv (IL)

Correspondence Address: ELIYAHOV AVRAHAM, P.O. Box 29746, TEL AVIV, IL, 61297, US

(21) Appl. No.: 12/803,421

(22) Filed: Jun. 28, 2010

Related U.S. Application Data
(63) Continuation of application No. PCT/IL08/01471, filed on Nov. 9, 2008.

(30) Foreign Application Priority Data
Nov. 11, 2007 (IL) 187291

(51) Int. Cl. A61H 13/00; A61H 1/00; A61C 19/06

(52) U.S. Cl. 433/80; 601/139; 601/142; 601/46

(57) ABSTRACT

A gingival massaging device comprising a dental arch shaped body for positioning within the oral cavity between the gingiva and the tissue linings of the lips, and the teeth, wherein the body comprises an internal track along which a plurality of massaging elements for massaging the gingiva are movable, wherein adjacent massaging elements are connected to each other by a mechanical linkage, wherein the device further comprises a shifting mechanism for moving the massaging elements along the track.

### RELATED APPLICATIONS

This application is a continuation of PCT Application No. PCT/IL2008/001471 filed on 9 Nov. 2008, which itself claims priority to Israeli Patent application no. 187291 filed on 11 Nov. 2007.

### FIELD OF THE INVENTION

The present invention relates in general to the field of dental devices. In particular, the present invention relates to a device for massaging and cleaning the gingiva.

### BACKGROUND OF THE INVENTION

The gingiva (or, gums) is the tissue that surrounds the tooth bearing bones in the oral cavity. Gingiva are part of the soft tissue lining of the mouth and provide a seal around the teeth and bones. Compared with the soft tissue linings of the lips and cheeks, most of the gingiva are tightly bound to the underlying bone and are designed to resist the friction of food passing over them. Healthy gingiva is usually coral pink, but may contain physiologic pigmentation. Changes in color, particularly increased redness, together with swelling and an increased tendency to bleed, suggest an inflammation that is possibly due to the accumulation of bacterial plaque.

In addition to the widely known and practiced methods of maintaining healthy gums, including flossing, using oral wooden sticks, etc., regular massaging of the gums is highly recommended. Research has shown that gentle non-damaging massaging of the gums promotes dental health. One method of performing regular massaging of the gums is to gently rub the bristles of the tooth brush over the gums while brushing one's teeth, morning and evening. However, this is often uncomfortable to the gums, and might even result in recession of the gum line, and in some cases, even bleeding.

JP 2001120579 discloses a gingival treatment tool for cleaning and sterilizing the teeth and gums by feeding a liquid thereto and massaging the gums. A bite plate for the upper and lower teeth is provided. A pump transfers cleaning fluid from an external supply of cleaning fluid to each bite plate via tubing. A plurality of oscillators is positioned along the outer wall of each bite plate for clean and massaging the teeth and gums. The bite plates of JP 2001120579 are not stand-alone devices, since they require the additional apparatus of the fluid supply, tubing, and pump.

WO 2004/108008 discloses an oral cleaning device comprising a bite plate having a U-shaped channel for being positioned around the upper or lower teeth. A plurality of activators (e.g. brushes) is positioned along the inner surface of the inner and outer walls of the bite plate, for cleaning or massaging the teeth and gums it surrounds. Each activator is rotated about its own axis by alternatingly pulling two wires that are connected to the rotating activators, and whose ends extend from the bite plate out of the mouth. The device requires two hands to operate, for pulling each wire. Moreover, the device design does not distinguish between teeth cleaning and gum massaging, such that the device, according to WO 2004/108008 uses the same activator to clean and massage. Thus, an abrasive material, which is suitable for brushing, might be used for massaging, and a soft material, whish is suitable for massaging, might be used for brushing.

It is therefore an object of the present invention to provide a gingival massaging device for providing a massaging sensation to the gingiva for preventing and treating gum diseases.

It is a further object of the present invention to provide a gingival massaging device that is a standalone device, and does not require attachment to any secondary device.

It is yet another object of the present invention to provide a gingival massaging device that is easy to use and requires no skill to operate.

It is still another object of the present invention to provide a gingival massaging device that is inexpensive to manufacture.

It is still another object of the present invention to provide a gingival massaging device that requires little or no maintenance.

Additional objects and advantages of the present invention will become apparent as the description proceeds.

### SUMMARY OF THE INVENTION

The present invention is directed to a gingival massaging device that comprises a dental arch shaped body for positioning within the oral cavity between the gingiva and the tissue linings of the lips, and the teeth, wherein the body comprises an internal track along which a plurality of massaging elements for massaging the gingiva are movable, wherein adjacent massaging elements are connected to each other by a mechanical linkage, wherein the device further comprises a shifting mechanism for moving the massaging elements along the track.

The massaging elements may be spherically shaped bodies. The mechanical linkage may be a wire, string or cable.

The massaging elements are rigidly connected to the mechanical linkage, such as a magnetic force. The path of the internal track may extend around the entire body in proximity to the outer edges of the body. The internal track may comprise an upper portion for contacting the upper gingiva and a lower portion for contacting the lower gingiva. The upper portion may comprise a first section for contacting the upper right gingiva and a second section for contacting the upper left gingiva, and the lower portion comprises a first section for contacting the lower right gingiva and a second section for contacting the lower left gingiva.

The mechanical linkage may be a flexible rod, which may be situated along the track. The device may further compris a handle element for grasping it.

The shifting mechanism may comprise a motor situated in the handle element, a rotatable hub having at least one arm extending radially therefrom. The shaft of the motor is rigidly fixed to the hub, such that upon rotation of the shaft, the hub rotates, and the arm contacts and pushes the massaging elements along the internal track.

The shifting mechanism may comprise a motor situated in the handle element, and a combination of gears and couplers that connect to each flexible rod for rotating each of the rods about its longitudinal axis.

The handle element may comprise a button portion situated at its tip for actuating the shifting mechanism.

The operating mode of the device may be changed by pressing the button to:
a) Increasing the rotational speed.
b) Decreasing the rotational speed.
c) Alternately switching the power on and off for certain periods of time.
d) Changing the rotational motion direction.
e) Alternately switching between rotational motion directions for certain periods of time in each direction.

The button may be replaced by a multi-mode switch for enabling each of the operating modes.

The device may be rechargeable and may be charged by placing it in a charger such that the electric contact points are in the handle element. The charger may have a protecting top cover.

The device may include a vibrating function, performed by the shifting mechanism, for causing the device to vibrate during use.

The internal track may be filled with a fluid such a medicament in the form of a gel or liquid, for reducing friction therein. Different fluids may have colors that correspond to a different type of fluid. The massaging elements may be filled with a medicament fluid, which is released during use, which can be a breath freshening agent, a tooth cleaning/whitening agent or a carries prevention agent.

The inner surface of the body may comprise a plurality of small openings therein to allow the fluid to exit therefrom.

The massaging elements may comprise colors that are fadable over time resulting from use of the device.

The may further include a shield in the form of a latticework located in the inner part of the device's body, for assisting the massaging process.

The device may include an outer track that is shifted by the motor and an inner track that is moved by a cogwheel system.

The motor may deliver rotational power to the arms by a cogwheel system which functions as a transmission. The device may be a multi-purpose device and can perform various types of treatments, depending on the fluid injected. Prior to activation, the fluid may be spread in the mouth.

### BRIEF DESCRIPTION OF THE DRAWINGS

In the drawings:

FIG. 1 illustrates a perspective view of the massaging device of the present invention;

FIG. 2 illustrates a back view of the massaging device of the present invention;

FIG. 3 illustrates a front view of the massaging device of the present invention;

FIG. 4 illustrates a schematic transverse cross-sectional view of the massaging device of the present invention;

FIGS. 5a and 5b illustrate a front view (FIG. 5a) and a perspective view (FIG. 5b) of the shifting mechanism of the present invention;

FIG. 6 illustrates a schematic perspective view of an alternative embodiment of the present invention;

FIG. 7 illustrates a perspective view of an alternative embodiment of the present invention;

FIGS. 8a, 8b and 8c illustrate a perspective view of a recharging system of the present invention; and

FIG. 9 illustrates a perspective view of an alternative embodiment of the present invention.

### DETAILED DESCRIPTION OF THE PREFERRED EMBODIMENTS

Healthy gums are vital for maintaining healthy teeth. Inflammation of the gums due to disease and other factors is uncomfortable and should be treated. Prior art devices have been developed to provide massaging and cleaning of the gums for maintaining health, and for preventing and treating disease. However, the prior art has drawbacks associated therewith, as described herein above. The present invention is a stand alone gingival massaging device for providing an improved massaging technique to the gingiva.

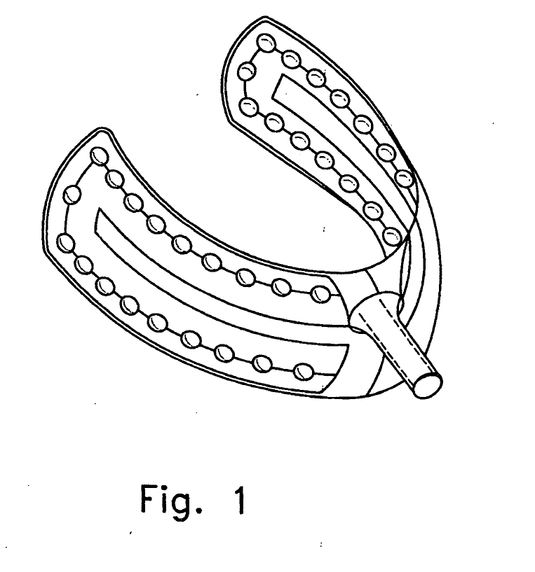

Referring to FIG. 1 a preferred embodiment of the gingival massaging device of the present invention is shown, designated generally by the numeral (10). Device (10) comprises a dental arch shaped body (12) for positioning comfortably within the oral cavity between the gingiva and the tissue linings of the lips, and the teeth. Body (12) comprises an outer layer (14) and an inner layer (16) that are joined to each other along their outer edges by a fastening strip (18). Outer and inner layers (14), (16) are additionally joined to each other along the central longitudinal axis of body (12), by outer and inner ribs (20), (22). A plurality of massaging elements (30) are situated within body (12) along an internal track (24), which is integrally formed by outer and inner layers (14), (16), as described herein below. Adjacent massaging elements (30) are connected to each other by a mechanical linkage (32).

Device (10) further comprises a handle element (40) with which the user is able to grasp device (10). A button portion (42) is positioned at the tip of handle element (40) for actuating a shifting mechanism, as described herein below. When the shifting mechanism is actuated, massaging elements (30) travel around internal track (24). The rubbing action of massaging elements (30) on the gums, which occurs as massaging elements travel around internal track (24), generates a massaging sensation on the gums.

As mentioned above, outer and inner layers (14), (16) are joined to each other along their outer edges and along the central axis of body (12). During the initial stage of the manufacturing process outer and inner layers (14), (16) are essentially flat; when joined together by fastening strip (18), a bubble shape is formed. Outer and inner layers (14), (16) are preferably made of a flexible, soft, yet firm material, such as silicon, or any other material exhibiting such characteristics. The material of outer and inner layers (14), (16) are shown to be transparent in the figures for clarity, however, in some embodiments an opaque material may be used.

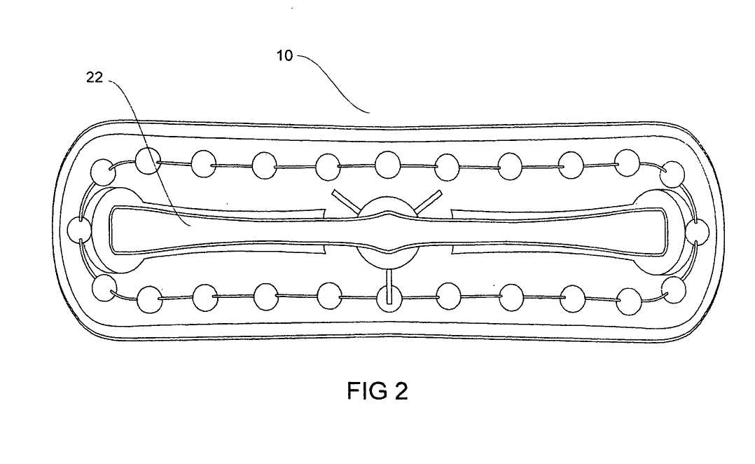

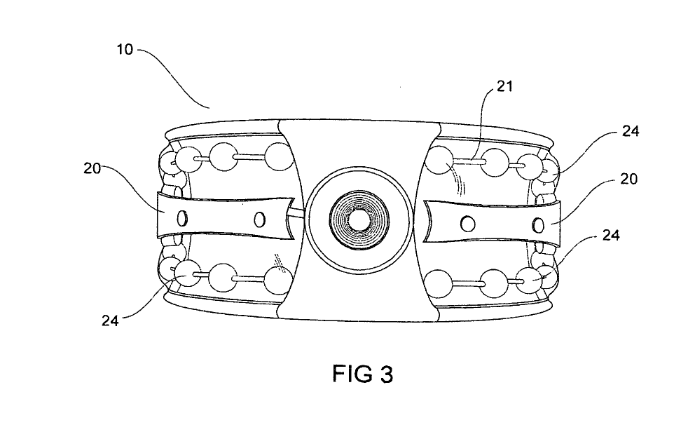

Arcuate ribs (20), (22) are positioned at the outer surface of outer and inner layers (14), (16) along the central longitudinal axis, thereby forming body (12) in a dental arch shape. As best seen in FIG. 2, showing a back view of device (10), inner rib (22) comprises a single rib that runs nearly the entire length of inner layer (16). Two outer ribs (20) (see FIG. 3) are joined to inner rib (22) via connectors (21), which may be any suitable fastening means for connecting ribs (20), (22) through layers (14), (16), such as pins, rivets, screws, etc. The ribs are preferably made of a semi-rigid material, such that when outer and inner ribs (20), (22) are joined, the bubble shape of body (12) is divided into two bubbles (or, bulges), thereby forming internal track (24), as described herein above.

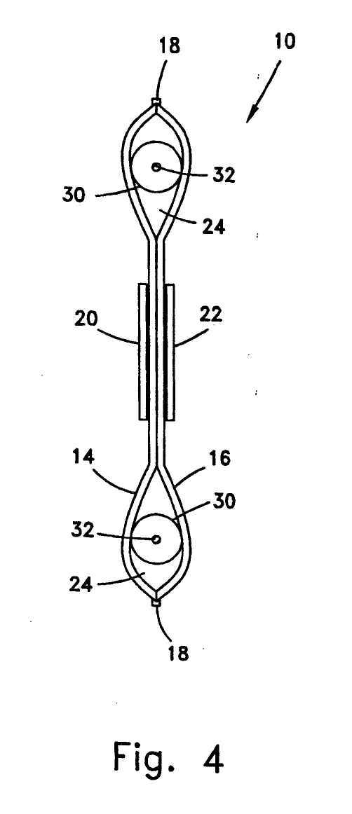

FIG. 3 shows a front view of device (10), wherein the bulges of internal track (24) are seen. A transverse cross-sectional view of device (10) is shown schematically in FIG. 4, and has a shape similar to that of a figure “8”. Referring to FIG. 3, and more particularly, FIG. 4, internal track (24) comprises the entire volume between outer layer (14) and inner layer (16) within which massaging elements (30) are disposed.

Massaging elements (30) are shown in the figures herein to be in the form of spherical bodies, e.g. balls. However, any suitably shaped massaging element (30) may be used for performing the gingival massaging with the present invention. Moreover, the number of massaging elements shown in the figures herein is for illustrative purposes only, and may vary depending on the size of device (10), among other factors.

Mechanical linkage (32) is shown herein to be a wire, string or cable, however, any suitable mechanical linkage may be used. For instance, massaging elements (30) may have a magnetic charge such that each element (30) is repelled from the adjacent element on each of its sides along internal track (24).

Each massaging element (30) is preferably rigidly connected to mechanical linkage (32) (in the case where mechanical linkage (32) is a physical object), or alternatively, may alternatively have the freedom to rotate along its axis in some embodiments.

In order to reduce the amount of friction present between massaging elements (30) and the inner surface of outer and inner layers (14), (16), a viscous fluid such as a gel or liquid (not shown) is contained within internal track (24). In some embodiments, at least inner layer comprises a plurality of small openings, through which the fluid may exit during the operation of device. In this case, the fluid preferably comprises a medicament having an active agent for treating or preventing gum disease, or otherwise promoting the health of the gums and/or teeth. In this case device (10) comprises an opening (not shown), which is selectively resealable for enabling refilling internal track (24) with a suitable fluid for reuse of device (10), after the old fluid is consumed. The color of the fluid provides indication about the type of medical treatment that it is suitable for (e.g., rebuilding of the external gingiva cells, whitening of teeth, etc.).

According to one aspect of the present invention, massaging elements (30) themselves are filled with a medicament, similar to that described herein above. In this case, massaging elements (30) comprise a plurality of openings through which the medicament exits. In this case, once the medicament is used up, massaging elements (30) must be removed from internal track (24) through the resealable opening described herein above, and replaced.

According to one aspect of the present invention, massaging elements (30), are colored, such that prolonged rubbing (massaging) of the gingiva by massaging elements (30) (through inner layer (16))results in the fading of the color. An indication to the user to replace the device with a new one may comprise a predetermined amount of fading, for instance, if the color fades up to or past an indicative marking on massaging element (30).

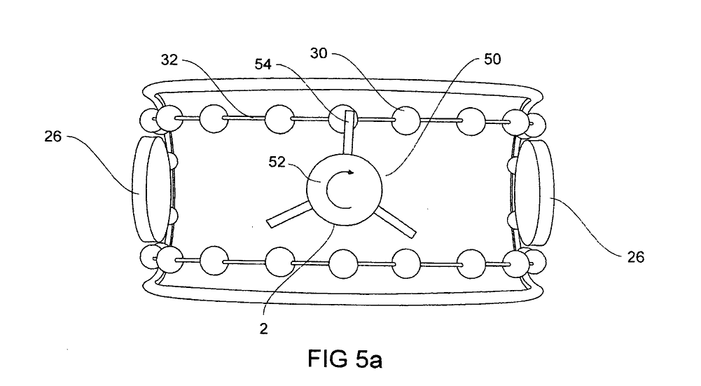

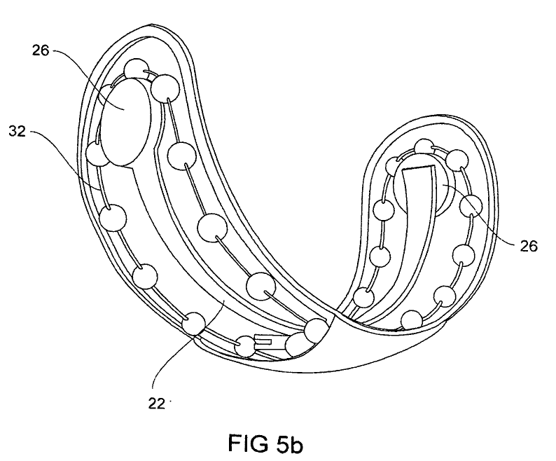

Referring to FIGS. 5a and 5b, a front view of (FIG. 5a) and perspective view (FIG. 5b) of some components shifting mechanism (50) is shown. Inner and outer layers (14), (16) as well as handle element (40) are removed for clarity.

Shifting mechanism (50) comprises a motor (not shown), which is situated within the handle element. The shaft (not shown) of the motor is rigidly affixed at the center of rotating hub (52). Three arms (or, vanes) (54) are situated equidistantly along hub (52), and extend radially outwardly therefrom. As best seen in FIG. 5b, the tip portion of each arm (54) comprises a fork for allowing mechanical linkage (32) to pass therethrough. When the button portion is pressed, the motor is activated, and the shaft rotates clockwise, as indicated by arrow (2). In turn, hub (52) and arms (54) rotate clockwise about the central axis of hub (52). When arms (54) are in the position shown in FIGS. 5a and 5b, upon activating the motor, the arm (54) situated closest to a massaging element (30) contacts and then pushes massaging element (30) along the path of the internal track. The distance that massaging elements (30) travel around the internal track is due to factors such as the strength of the motor, and the amount of friction present in the internal track between massaging elements (30) and the surface of outer and inner layers (14), (16).

Hub (52) is connected to inner rib (22) by a pin (not shown) or other coupling device that allows free rotation of hub (52) about its central axis.

As seen in the figures, a pulley, (or guide) (26) is situated at each of the longitudinal ends of body (12), and are connected to the longitudinal ends of inner rib (22). Preferably, pulleys (26) are connected to inner rib (22) by a pin (not shown) or other coupling device that allows free rotation of the pulleys as massaging devices (30) and mechanical linkage (32) travel around pulleys (26), through the internal track. Alternatively, pulleys (26) may be rigidly connected to inner rib (22).

Referring, for example, to FIG. 1, button portion (42) may be of the type that, upon pressing once, turns and remains in an “on” position, and, upon pressing a second time, turns and remains in an “off” position. Alternatively, button portion (42) may be of the type that has a normal state in the “off” position, and the user must press and hold down button portion (42) to turn and maintain the “on” position.

In a preferred embodiment of the present invention, each time the button is pressed it can change the operating mode, for instance increase or decrease the speed, having the device alternately turn on and off for certain periods of time. Another mode can be changing the circular motion direction. Another mode can be having the device alternately change its circular motion direction for certain periods of time in each direction. In another preferred embodiment of the present invention, a multiple mode switch can be used for enabling each of the modes above. Such multiple mode switch can replace of or be installed in addition to the regular button.

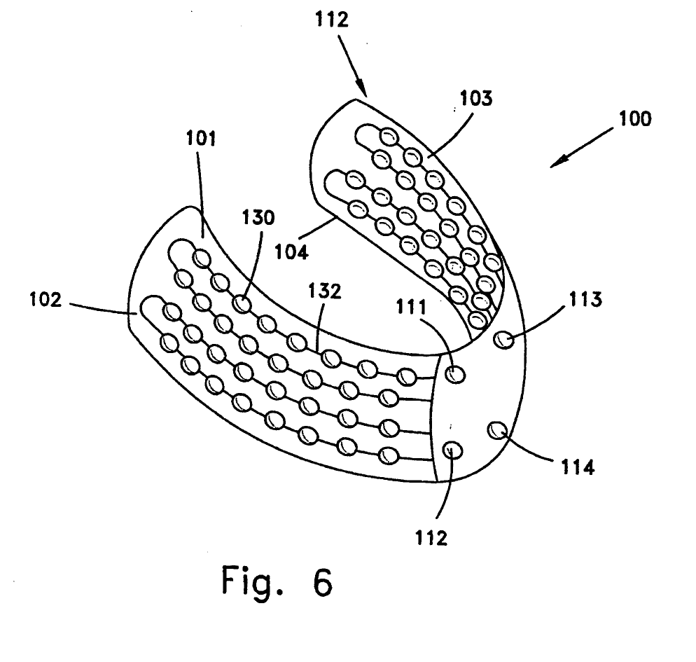

An alternative embodiment of the device (100) of the present invention is shown schematically in FIG. 6, and comprises all of the essential and advantageous features as described with regard to the first embodiment, mutatis mutandis, with the following differences. For the sake of clarity of the description, device (100) may be divided into four quadrants: Two upper quadrants (101), (103) and two lower quadrants (102), (104).

It should be noted that the directional terms, “upper” and, “lower” are merely used herein for the sake of convention. Device (100) (as well as device (10)) of the present invention is designed for disposing within the oral cavity regardless of it's orientation, so long as the dental arch shape of the body fits around the dental arch within the cavity.

Each quadrant (101), (102), (103), (104) comprises a plurality of massaging elements (130) connected to a mechanical linkage (132). Mechanical linkage (132) is a flexible rod, and massaging elements (130) are integrally joined thereto. Each mechanical linkage (132) extends within the internal track (not shown), from near the center of body (112) to near the longitudinal end of body (112). The end of each mechanical linkage (132) situated near the center of body (112) is connected to the shaft (not shown) of a motor (not shown). The handle portion (not shown) comprises a single motor having four shafts, or alternatively, four separate motors, each having a single shaft.

A combination of gears and couplers may be used to connect each mechanical linkage (132) with each shaft at (111), (112), (113), (114), such that upon rotation of the shaft about its longitudinal axis, the respective mechanical linkage (132) rotates about its longitudinal axis, which is orthogonal to the longitudinal axis of the shaft. Such a combination of gears and couplers is known by the man skilled in the art, and does not need to be elaborated upon herein.

According to one aspect of all embodiments, the device of the present invention comprises a vibrating function. Vibration of the device has two benefits. First, the vibrating movement promotes further blood circulation in the gums in addition to the rubbing action provided by the movement of the massaging elements. Second, the vibration preferably reverberates throughout the entire face, thereby relaxing the muscles therein. Vibration is performed by the motor located within the handle portion. A single motor may be used, which has multiple functions (e.g. rotation, vibration) for causing movement of massaging elements (30).

Alternatively, more than one motor may be present within the handle portion for providing the different functions. It is understood that modifications and adjustments to the design of the device of the present invention as shown in the figures herein are required in order to comply with the additional or alternative functions of the device.

According to one aspect of all embodiments, a docking/recharging station (not shown) is provided for accommodating the device of the present invention. Preferably, one or more connectors are provided at the tip of the handle portion, on or in proximity to the button portion. Between uses, the device is inserted to the docking station at the handle portion, to allow recharging of the battery situated within the handle portion to take place. Alternatively, when the battery is exhausted, it may be removed and replaced with a new one.

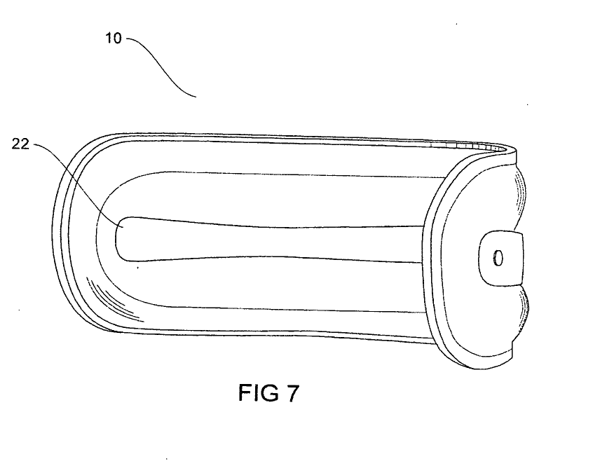

In another embodiment of the present invention, the device includes a shield (200) in the form of a latticework as shown in FIG. 7. The shield is located in the inner part of the dental arch shaped body (212), closer to the gingiva (when in use) in relation to the massaging elements (230).

The massaging elements (230) move on their axis traveling around the internal track while massaging the gingiva as described earlier, and also press on the shield (200). Pressing of the massaging elements (230) on the shield (200) causes the shield (200) to additionally rub the gingiva to assist massaging. The shield (200) increases the massaging effect applied by the massaging elements (230) and also assists cleaning the mouth. Due to the shield (200) the massaging process covers a larger area of the gingiva, thereby obtaining a more efficient treatment.

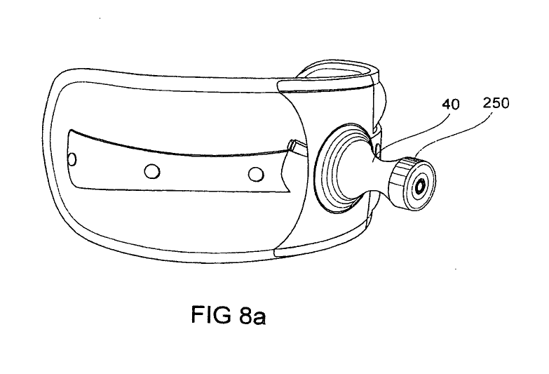

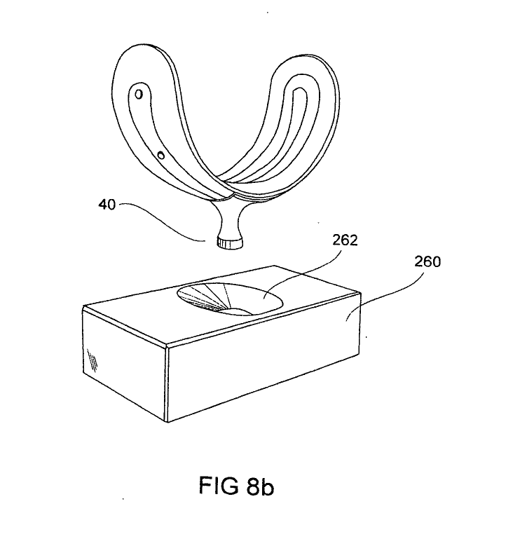

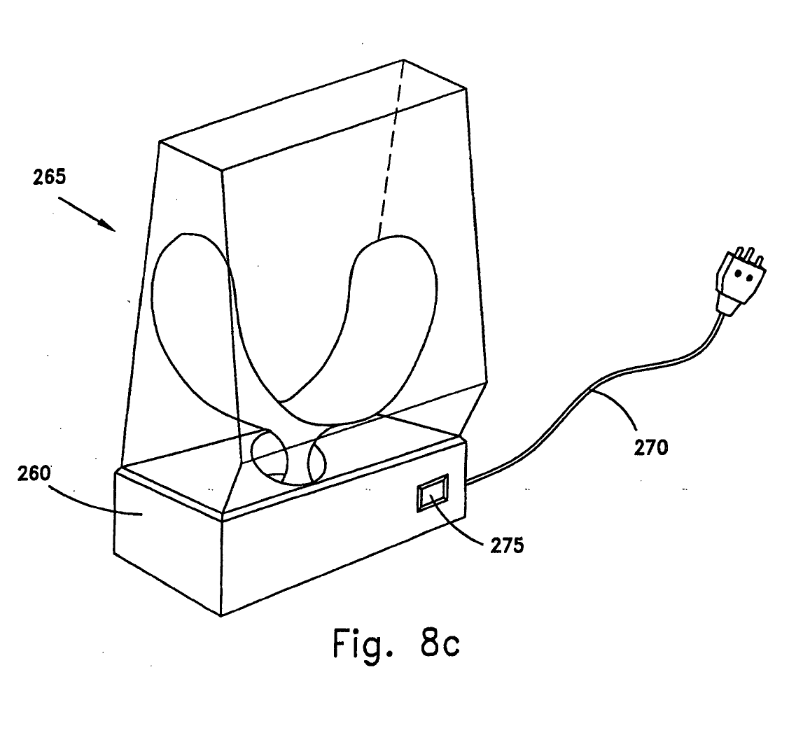

In another embodiment of the present invention the electric power for activating the motor which circulates the massaging element system is supplied by an internal rechargeable battery inside the handle element (40). As shown in FIG. 8a, 2 depressions are provided on the handle element (40), the positive contact (251) and the negative contact (252) of the rechargeable internal battery. In order to recharge the internal battery the device should be place in the device charger (260), as shown in FIG. 8b, having handle element face down suitable to place in the charging hole (262).

Contact points (251) and (252) will make contact with their compatible contacts inside the device charger (260). The device charger (260) can also have an oval or circular or any other shape.

In a preferred embodiment of the present invention, the device charger (260) can have a protecting cover top (265) which protects the device while charging, as shown in FIG. 8c. The protecting cover top (265) can protect the device from undesired hits it can accidentally get while charging. It also protects the device from dust and dirt. The device charger (260) can have a standard cable (270) that connects to a home electrical outlet. The device charger (260) can have an indicating LED (275) that can indicate whether or not the device is fully charged.

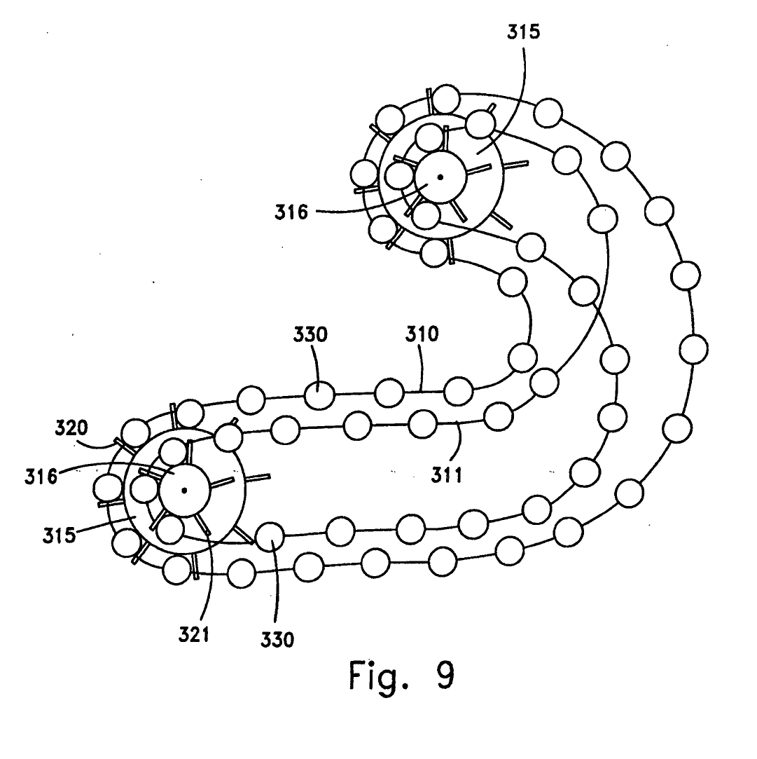

In a preferred embodiment of the present invention, a plurality of massaging elements is situated within the body of the device along an internal track. Adjacent massaging elements are connected to each other by a mechanical connection. In this preferred embodiment there are two tracks, an outer track (310) and an inner track (311) as shown in FIG. 9.

There are two larger cogwheels (315) at the edges of the circular elliptic course of the outer track. The device motor only turns the outer track (310). When the massaging elements (330) of the outer track (310) engage with the large cog-wheel (315) they push the cogs (320), thus forcing the larger cogwheel (315) to rotate. The two larger cogwheels (315) have two smaller cogwheels (316) attached to them such that when the large cogwheel (315) rotates, the small cog-wheel (316) rotates at the same angular speed. The small wheel cogs (321) push the massaging elements (330) of the inner track (311) causing the inner track (311) to move on its course.

In summary the motor causes the outer track (310) to turn. The outer track massage elements (330) push the large cog-wheel cogs (320) causing the large cog-wheel (315) to turn (and also the small cog-wheel (316) attached to the large one). The cogs (321) of the small cog-wheel (316) push the massaging elements (330) causing the inner track (311) to turn. This arrangement allows a more efficient massage over a wider area.

If it is needed it is possible to enlarge the force applied on the outer track (310) by means of mechanical transmission that includes a system of certain cogwheels in the motor system, located between the motor drive shaft and the shifting mechanism. The motor drive shaft turns a small cogwheel and the small cogwheel turns a larger cogwheel attached to the shifting mechanism, while the speed of the shifting mechanism will decrease accordingly.

The invention is a multi-purpose device and can perform various types of treatments, depending on the fluid injected into it, for instance material for treatment of the gums, material for whitening of the teeth, taste and fragrance material, aromatic oils etc. These materials can be injected into the device and exit the device from certain openings during operation of the device. These materials can be externally spread in certain areas in the mouth prior to activating the device.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A gingival massaging device comprising a dental arch shaped body for positioning within the oral cavity between the gingiva and the tissue linings of the lips, and the teeth, wherein said body comprises an internal track along which a plurality of massaging elements for massaging said gingiva are movable, wherein adjacent massaging elements are connected to each other by a mechanical linkage, wherein said device further comprises a shifting mechanism for moving said massaging elements along said track.

2. The device according to claim 1, wherein the massaging elements are spherically shaped bodies.

3. The device according to claim 1, wherein the mechanical linkage is a wire, string or cable AND wherein the said massaging elements are rigidly connected to the said mechanical linkage AND wherein the said mechanical linkage is a magnetic force.

4. The device according to claim 1, wherein the path of the internal track extends around the entire body in proximity to the outer edges of said body AND wherein the internal track comprises an upper portion for contacting the upper gingiva and a lower portion for contacting the lower gingival.

5. The device according to claim 4, wherein the upper portion comprises a first section for contacting the upper right gingiva and a second section for contacting the upper left gingiva, and the lower portion comprises a first section for contacting the lower right gingiva and a second section for contacting the lower left gingival AND wherein the said mechanical linkage is a flexible rod AND wherein each section comprises a flexible rod situated along the track AND further comprising a handle element for grasping said device AND wherein the shifting mechanism comprises at least one motor situated in the handle element, and a combination of gears and couplers that connect to each flexible rod for rotating each of said rods about its longitudinal axis.

6. The device according to claim 4, further comprising a handle element for grasping said device AND wherein the shifting mechanism comprises at least one motor situated in the handle element, a rotatable hub having at least one arm extending radially therefrom, wherein the shaft of said motor is rigidly fixed to said hub, such that upon rotation of said shaft, said hub rotates, and said arm contacts and pushes the massaging elements along the internal track.

7. The device according to any one of claim 5, wherein the handle element comprises a button portion situated at its tip for actuating the shifting mechanism AND wherein the operating mode of the device is changed by pressing the button, to perform one or more of the following operations:
a) Increasing the rotational speed.
b) Decreasing the rotational speed.
c) Alternately switching the power on and off for certain periods of time.
d) Changing the rotational motion direction.
e) Alternately switching between rotational motion directions for certain periods of time in each direction.

8. The device according to claim 1, comprising a vibrating function for causing said device to vibrate during use AND wherein the internal track is filled with a fluid such as a gel or liquid, for reducing friction therein.

9. The device according to claim 1, wherein the fluid is a medicament AND wherein different fluids have colors that correspond to a different type of fluid AND wherein the inner surface of the body comprises a plurality of small openings therein to allow the fluid to exit therefrom.

10. The device according to claim 1, wherein the massaging elements are filled with a medicament fluid, which is released during use.

11. The device according to any one of claim 9, wherein the fluid may be chosen from the group consisting of:
a. a breath freshening agent;
b. a tooth cleaning/whitening agent; and,
c. a carries prevention agent.

12. The device according to claim 1, wherein the massaging elements comprise colors that are fadable over time resulting from use of said device.

13. The device according to claim 1, further including a shield in the form of a latticework located in the inner part of the device's body, for assisting the massaging process.

14. The device according to claim 1, including an outer track that is shifted by the motor and an inner track that is moved by a cogwheel system.

15. The device according to claim 14, wherein the motor delivers rotational power to the arms by a cogwheel system which functions as a transmission.

16. The device according to claim 1, wherein the device is a multi-purpose device and can perform various types of treatments, depending on the fluid injected.

17. The device according to claim 16, wherein prior to activation the fluid is spread in the mouth.
